(19) United States
(12) Patent Application Publication
(10) Pub. No.: US 2010/0135448 A1
(43) Pub. Date: Jun. 3, 2010

(54) SHARING APPARATUS OF REFERENCE SYNCHRONIZATION SIGNAL AND METHOD THEREOF

(75) Inventors: Joo Ho PARK, Daejeon (KR); Jae Young KIM, Daejeon (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon (KR)

(21) Appl. No.: 12/629,334

(22) Filed: Dec. 2, 2009

(30) Foreign Application Priority Data
Dec. 3, 2008 (KR) 10-2008-0122007
Mar. 26, 2009 (KR) 10-2009-0025974

(51) Int. Cl. H04L 7/04

(52) U.S. Cl. 375/362

(57) ABSTRACT

Provided are a reference synchronization signal sharing apparatus and a method thereof. The reference synchronization signal sharing apparatus according to the present invention includes a reference signal generator that generates an internal or external reference synchronization signal, and a system clock generator that generates a common system clock for detailed blocks of a wireless communication system in synchronization with the internal or external reference synchronization signal.

### CROSS-REFERENCE TO RELATED APPLICATION

This application claims priority to and the benefit of Korean Patent Application Nos. 10-2008-0122007 and 10-2009-0025974 filed in the Korean Intellectual Property Office on Dec. 3, 2008 and Mar. 26, 2009, the entire contents of which are incorporated herein by reference.

### BACKGROUND OF THE INVENTION

(a) Field of the Invention

The present invention relates to a reference synchronization signal sharing apparatus and a method thereof.

(b) Description of the Related Art

A conventional wireless communication system uses an initial reference synchronization signal for synchronization in order to generate a system clock required for detailed blocks of the system.

However, in a substantial system configuration, the system clock is generated with a separate reference synchronization signal generator of the same frequency component rather than generating the system clock by using one reference synchronization signal generator.

In addition, a signal path may be provided for receiving a reference synchronization signal from an independent external system. In this case, convenience can be provided since the detailed blocks can be independently tested and operated by using the internal reference synchronization signal.

However, when performing system integrating, testing, and operation for system interaction, several reference synchronization signals are used so that a system clock frequency error may occur due to a difference of unique frequency characteristics of the reference synchronization signals.

In addition, the reference synchronization signals are separately operated so that the unique frequency characteristics may be deteriorated due to interference between the reference synchronization signals.

Therefore, a reference synchronization signal generator for each block is separately manufactured and used so that system performance and operation may be deteriorated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a reference synchronization signal sharing apparatus and a method thereof.

According to an exemplary embodiment of the present invention, a reference synchronization signal sharing apparatus is provided. The reference synchronization signal sharing apparatus includes a reference signal generator that generates an internal reference synchronization signal or an external reference synchronization signal and a system clock generator that generates a common system clock for detailed blocks of a wireless communication system in synchronization with the internal or external reference synchronization signal.

According to another exemplary embodiment of the present invention, a reference synchronization signal sharing method is provided. The reference synchronization signal sharing method includes detecting whether an internal reference synchronization signal or an external reference synchronization signal is generated and generating a common system clock for detailed blocks that form a wireless communication system in synchronization with the internal reference synchronization signal or the external reference synchronization signal.

### BRIEF DESCRIPTION OF THE DRAWINGS

FIG. 1 is a block diagram of a configuration of a reference synchronization signal sharing apparatus according to an exemplary embodiment of the present invention.

FIG. 2 is a block diagram of a configuration of a signal detection unit according to the exemplary embodiment of the present invention.

FIG. 3 shows a flow of an internal reference synchronization signal according to the exemplary embodiment of the present invention.

FIG. 4 shows a flow of an external reference synchronization signal according to the exemplary embodiment of the present invention.

FIG. 5 is a flowchart of operation of the reference synchronization signal sharing apparatus according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

In the specification, a reference synchronization signal sharing apparatus is formed of detailed blocks that operate by generating a system clock signal at a specific operation frequency by using a reference synchronization signal. During operation, while maintaining generation of independent reference synchronization signal, the detailed blocks are synchronized with input or output of an internal or external reference synchronization signal of a reference synchronization signal sharing apparatus when a system is synchronized by a single reference synchronization signal or a reference synchronization signal needs to be shared.

Hereinafter, a reference synchronization signal sharing apparatus and a method thereof according to an exemplary embodiment of the present invention will be described in detail with reference to the drawings.

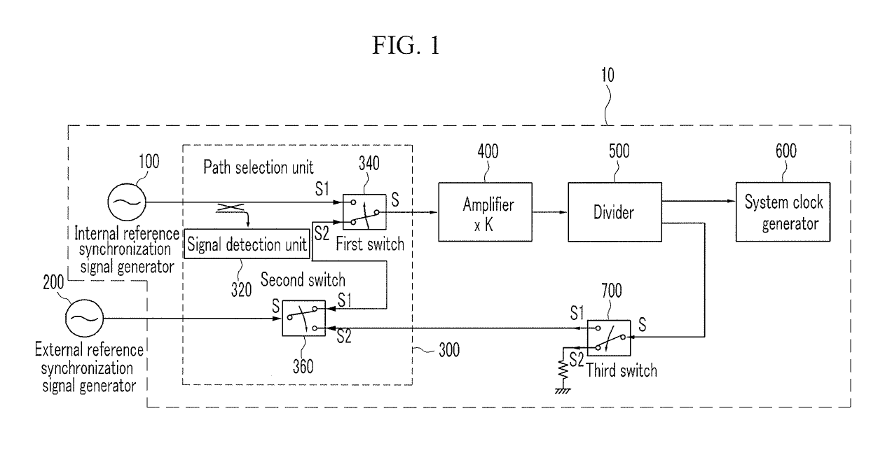

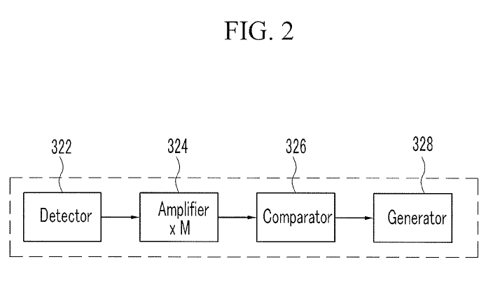

FIG. 1 is a block diagram of a configuration of a reference synchronization signal sharing apparatus according to an exemplary embodiment of the present invention, and FIG. 2 is a block diagram of a signal detection unit according to the exemplary embodiment of the present invention.

Referring to FIG. 1, a reference synchronization signal sharing apparatus 10 includes an internal reference synchronization signal generator 100, a selection unit 300, an amplifier 400, a dividing unit 500, a system clock generator 600, and a third switch 700. In this case, the internal reference synchronization signal generator 100 is connected to a signal detection unit 320 and a first switch 340. The first switch 340 is connected to the amplifier 400, and the amplifier 400 is connected to the dividing unit 500. The dividing unit 500 is connected to the system clock generator 600 and the third switch 700. An external reference synchronization signal generator 200 is connected to a second switch 360, and the second switch 360 is connected to the first and third switches 340 and 700.

When a system clock is generated and power is supplied to the entire constituent devices for data transmission and normal operation, all the blocks in FIG. 1 basically perform normal operation. In a state that no external reference synchronization signal for system clock generation is provided, an internal reference synchronization signal basically generates its unique frequency for operation.

A reference synchronization signal may be generated by using a temperature controlled crystal oscillator (TCXO) that is not sensitive to temperature and circumstances, and may be selected in consideration of frequency stability characteristics according to a wireless transmitting/receiving system.

The signal detection unit 320, the first switch 340, and the second switch 360 form the path selection unit 300.

When the internal reference synchronization signal generator 100 or the external reference synchronization signal generator 200 respectively generates an internal reference synchronization signal or an external reference synchronization signal, the path selection unit 300 selects a path that is different according to the generated signal. That is, the path selection unit 300 controls operation of the first and second switches 340 and 360.

The signal detection unit 320 detects the internal reference synchronization signal, and includes the detailed constituent elements shown in FIG. 2.

Referring to FIG. 2, the signal detection unit 320 includes a detector 322, an amplifier 324, a comparator 326, and a generator 328.

The detector 322 may be an envelope detector. When an internal reference synchronization signal is generated, the detector 322 detects the internal reference synchronization signal through the envelop detector.

The amplifier 324 controls a signal level of the internal reference synchronization signal detected by the detector 322 and outputs the signal level that is controlled as an input signal of the comparator 326.

The comparator 326 outputs a control signal according to whether or not an internal reference synchronization signal is detected based on the internal reference synchronization signal received from the amplifier 324. The comparator 326 outputs a high-level signal when the internal reference synchronization signal input from the amplifier 324 is higher than a threshold voltage. In addition, the comparator 326 outputs a low-level signal when the internal reference synchronization signal input from the amplifier 324 is lower than the threshold voltage.

The generator 328 generates a switch control signal according to a signal level output from the comparator 326 for path selection according to the internal reference synchronization signal or the external reference synchronization signal. That is, when the internal reference synchronization signal detection is checked through the signal level output from the comparator 326, the generator 328 selects a path of the first switch 340 as “S→S1” to generate a corresponding switch control signal. In this case, a switch control signal may be generated and provided for selection of a path of the third switch 700 as “S→S2”.

In addition, when the external reference synchronization signal is used as the reference synchronization signal and the detector 322 detects that no internal reference synchronization signal is generated and inputs the detection signal to the comparator 326 through the amplifier 324, the comparator 326 inputs a low-level signal to the generator 328. The generator 328 selects the path of the first switch 340 as “S->S2” to generate a corresponding switch control signal. In addition, the path of the second switch 360 is selected as “S→S1”.

The amplifier 400 receives the internal reference synchronization signal or the external reference synchronization signal through the path selected by the path selection unit 300 to control a signal level. That is, the signal level is increased through signal level control after consideration of signal attenuation for normal system clock generation.

The dividing unit 500 divides the internal reference synchronization signal or the external reference synchronization signal output from the amplifier 400 by a number of paths required for the reference synchronization signal. The internal reference synchronization signal or the external reference synchronization signal divided by the dividing unit 500 is input to the system clock generator 600 or the third switch 700.

The system clock generator 600 generates a common system clock for detailed blocks of the wireless communication system in synchronization with the internal or external reference synchronization signal. That is, the system clock generator 600 generates a synchronization system clock of the entire system.

The third switch 700 may be manufactured as hardware to manually select the path according to a system specification. The third switch 700 can output the internal or external reference synchronization signal divided by the dividing unit 500 to a 50 Ohm terminator or to the outside. In this case, when the internal reference synchronization signal or the external reference synchronization signal is output to the outside, the second switch 360 is connected to “S” from “S2”. Thereby, the internal or external reference synchronization signal can be outputted through an external terminal and be used as a reference synchronization signal of another system.

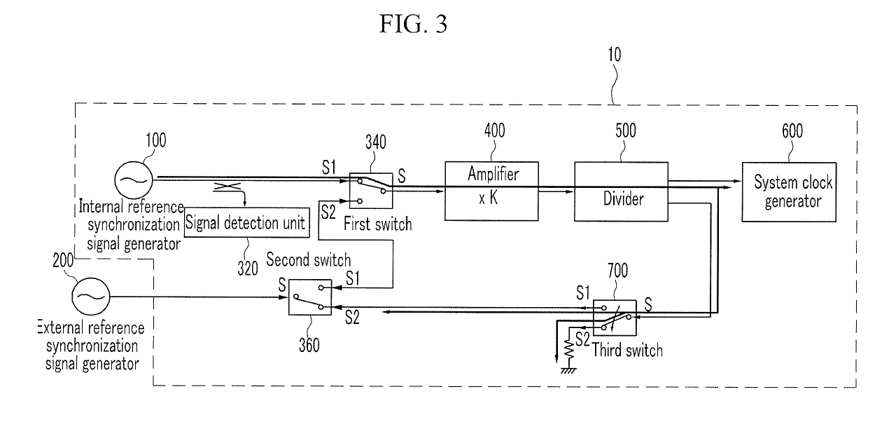

FIG. 3 shows a flow of the internal reference synchronization signal according to the exemplary embodiment of the present invention.

Referring to FIG. 3, when the signal detection unit 320 detects the internal reference synchronization signal generated by the internal reference synchronization signal generator 100, the first switch 340 is connected to “S” from “S1”. The internal reference synchronization signal is passed through the amplifier 400 and the dividing unit 500 through the first switch 340, and is input as a reference synchronization signal to the system clock generator 600. In addition, the internal reference synchronization signal is input to the third switch 700, passed through the third switch 700, and output to an external terminal or a ground terminal.

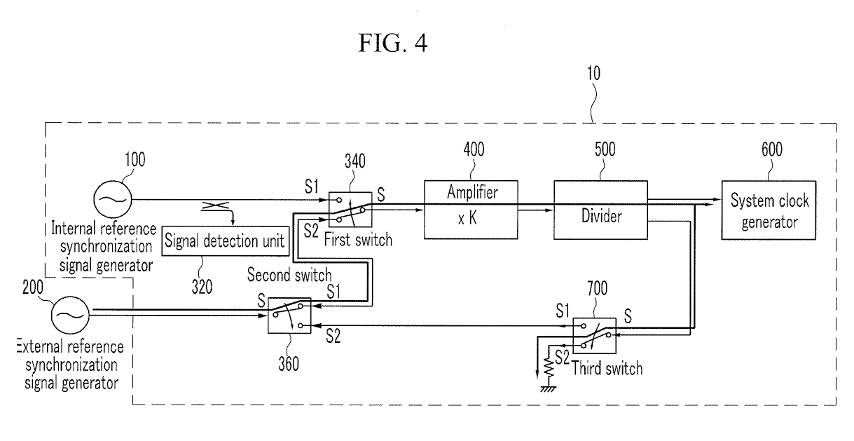

FIG. 4 shows flow of the external reference synchronization signal according to the exemplary embodiment of the present invention.

In this case, when an external reference synchronization signal is used, the external reference synchronization signal is used after blocking or eliminating power supply to the internal reference synchronization signal generator 100 to prevent generation of an internal reference synchronization signal.

Referring to FIG. 4, the generation of the internal reference synchronization signal is prevented, and therefore the first switch 340 is connected from “S2” to “S1” if the signal detection unit 320 cannot detect an internal reference synchronization signal.

When the external reference synchronization signal generator 200 generates an external reference synchronization signal and the first switch is connected from “S2” to “S1”, the second switch 360 is connected to “S1” from “S”. The external reference synchronization signal is passed through the amplifier 400 and the driving unit 500 through the second switch 360 and the first switch 340, and is input as a reference synchronization signal to the system clock generator 600. In addition, the external reference synchronization signal is input to the third switch 700 and passed therethrough and then output to a ground terminal.

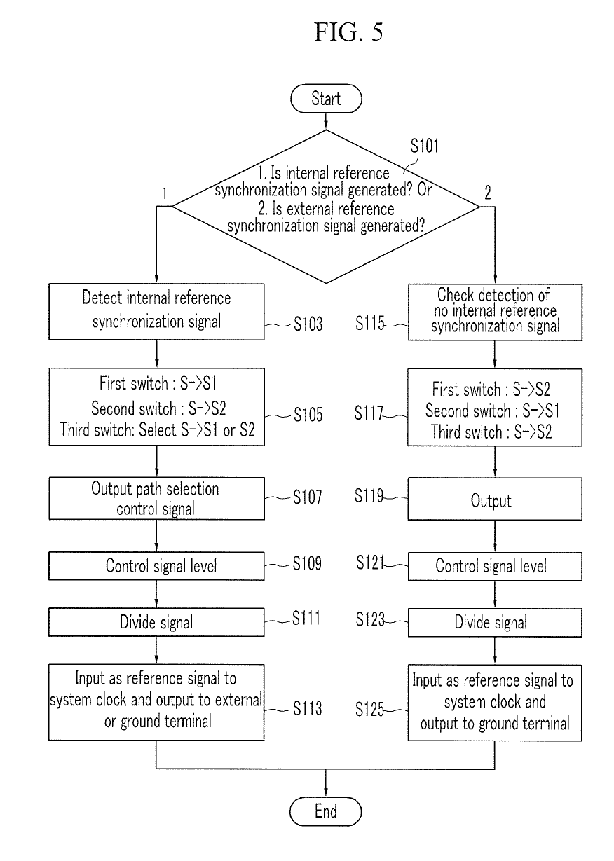

FIG. 5 is a flowchart of a reference synchronization signal sharing method according to the exemplary embodiment of the present invention. That is, FIG. 5 shows an operation method of a reference synchronization signal sharing device of FIG. 1 and FIG. 2.

Referring to FIG. 5, the path selection unit 300 determines generation of an internal reference synchronization signal or an external reference synchronization signal (S101).

When the internal reference synchronization signal is detected (S103), a path for selecting an internal reference synchronization signal as a reference synchronization signal for generating a system clock is selected (S105), and a path selection control signal is output (S107). That is, the first switch 340 is connected from “S1” to “5”. In this case, the second switch 360 is connected from “S2” to “S”, and the third switch 700 is connected from “S2” to “S” or from “S1” to “S”.

The internal reference synchronization signal is passed through the first switch 340, the amplifier 400, and the dividing unit 500 (S109 and S111), and is input as a reference synchronization signal to the system clock generator 600 (S113). In addition, according to path selection of the third switch 700, the internal reference synchronization signal is output to the external or ground terminal (S113).

In addition, when the external reference synchronization signal is detected (S115), a path for selecting the external reference synchronization signal as a reference synchronization signal for generating a system clock is selected (S117), and a path selection control signal is output (S119). That is, the first switch is connected from “S2” to “S”. In this case, the second switch is connected from “S1” to “S” and the third switch is connected from “S2” to “S”.

The external reference synchronization signal is passed through the second switch 360, the first switch 340, the amplifier 400, and the dividing unit 500 (S121 and S123), and is input as a reference synchronization signal to the system clock generator 600 (S125). In addition, the external reference synchronization signal is output to the ground terminal through the third switch 700 (S125).

According to the exemplary embodiments of the present invention, a system clock is generated by using an internal or external reference synchronization signal, and the system clock can be commonly applied to a synchronization system.

In addition, an internally generated signal or an external input signal is used as a reference signal for generating the system clock so that unique frequency characteristics and a stable reference synchronization signal can be provided.

Further, an allowable frequency error limit of a transmitting/receiving device can be reduced and data modulation/demodulation performance can be improved by generating a system clock having high stability and excellent characteristics in the synchronization system.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A reference synchronization signal sharing apparatus comprising:
a reference signal generator that generates an internal reference synchronization signal or an external reference synchronization signal; and
a system clock generator that generates a common system clock for detailed blocks of a wireless communication system in synchronization with the internal reference synchronization signal or external reference synchronization signal.

2. The reference synchronization signal sharing apparatus of claim 1, further comprising:
a path selection unit that detects the internal reference synchronization signal or the external reference synchronization signal and selects an input path of the detected signal to the system clock generator according to whether the detected signal is the internal reference synchronization signal or the external reference synchronization signal;
an amplifier that receives the internal reference synchronization signal or the external reference synchronization signal through a path selected by the path selection unit, and controls a signal level of the received signal; and
a divider that divides the internal reference synchronization signal or the external reference synchronization signal output from the amplifier by a number of paths required for a reference synchronization signal, and inputs the divided signal to the system clock generator.

3. The reference synchronization signal sharing apparatus of claim 2, wherein the path selection unit comprises:
a first switch that forms an input path for the internal reference synchronization signal to the system clock generator;
a second switch that forms an input path for the external reference synchronization signal to the system clock generator;
a detector that detects generation of the internal reference synchronization signal;
a comparator that outputs a control signal according to whether or not the detector detects the internal reference synchronization signal; and
a generator that generates a switch control signal for operating the first switch or the second switch according to the control signal output from the comparator.

4. The reference synchronization signal sharing apparatus of claim 3, further comprising a third switch that receives the internal reference synchronization signal or the external reference synchronization signal output from the divider and outputs the received signal to a predetermined path that includes a ground terminal and an external terminal.

5. A reference synchronization signal sharing method comprising:
detecting whether an internal reference synchronization signal or an external reference synchronization signal is generated; and
generating a common system clock for detailed blocks that form a wireless communication system in synchronization with the internal reference synchronization signal or the external reference synchronization signal.

6. The reference synchronization signal sharing method of claim 5, wherein the detecting comprises:
determining whether or not the internal reference synchronization signal is detected;
when the internal reference synchronization signal is detected, selecting a path for selecting the internal reference synchronization signal as a reference synchronization signal for generating the common system clock; and
when the external reference synchronization signal is detected, selecting a path for selection of the external reference synchronization signal as the reference synchronization signal for generating the common system clock.

7. The reference synchronization signal sharing method of claim 5, wherein the generating comprises:
controlling a level of the internal reference synchronization signal or the external reference synchronization signal;
dividing the level-controlled internal or external reference synchronization signal by a number of paths required for the reference synchronization signal;
generating a common system clock by using the divided internal or external reference synchronization signal; and
outputting the divided internal or external reference synchronization signal to a predetermined path that includes a ground terminal or an external terminal.

8. The reference synchronization signal sharing method of claim 6, wherein the generating comprises:
controlling a level of the internal reference synchronization signal or the external reference synchronization signal;
dividing the level-controlled internal or external reference synchronization signal by a number of paths required for the reference synchronization signal;
generating a common system clock by using the divided internal or external reference synchronization signal; and
outputting the divided internal or external reference synchronization signal to a predetermined path that includes a ground terminal or an external terminal.
